(19) United States
(12) Patent Application Publication
(10) Pub. No.: US 2021/0051917 A1
(43) Pub. Date: Feb. 25, 2021

(54) Pet Carrying Assembly

(71) Applicant: Laurie Ross, Maple (CA)

(72) Inventor: Laurie Ross, Maple (CA)

(21) Appl. No.: 16/544,481

(22) Filed: Aug. 19, 2019

(51) Int. Cl. A01K 1/02; A01K 1/015

(52) U.S. Cl. CPC A01K 1/0245; A01K 1/0157

(57) ABSTRACT

A pet carrying assembly for transporting a pet includes a case that defines an interior space. The case is clam-shell type and is configured to position a pet in the interior space. A set of first couplers and a set of second couplers are coupled to a forward edge of an upper section and a front edge of a lower section of the case, respectively. The second couplers are complementary to the first couplers so that each second coupler is positioned to selectively couple to an associated first coupler to couple the upper section to the lower section. A handgrip that is coupled to a top of the case is configured to be grasped in a hand of a user to lift the case. A set of rollers that is coupled to a bottom of the case is configured to locomote the case across a substantially horizontal surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to carrying assemblies and more particularly pertains to a new carrying assembly for transporting a pet.

### (2) Description of Related Art Including Information Disclosed Under 37 CFR 1.97 and 1.98

The prior art relates to a carrying assembly.

### BRIEF SUMMARY OF THE INVENTION

An embodiment of the disclosure meets the needs presented above by generally comprising a case that defines an interior space. The case is clam-shell type and is configured to position a pet in the interior space. A set of first couplers and a set of second couplers are coupled to a forward edge of an upper section and a front edge of a lower section of the case, respectively. The second couplers are complementary to the first couplers so that each second coupler is positioned to selectively couple to an associated first coupler to couple the upper section to the lower section. A handgrip that is coupled to a top of the case is configured to be grasped in a hand of a user to lift the case. A set of rollers that is coupled to a bottom of the case is configured to locomote the case across a substantially horizontal surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a pet carrying assembly according to an embodiment of the disclosure.

FIG. 2 is a front view of an embodiment of the disclosure.

FIG. 3 is a rear view of an embodiment of the disclosure.

FIG. 4 is a side view of an embodiment of the disclosure.

FIG. 5 is a top view of an embodiment of the disclosure.

FIG. 6 is a bottom view of an embodiment of the disclosure.

FIG. 7 is an in-use view of an embodiment of the disclosure.

FIG. 8 is an isometric perspective view of an alternative embodiment of the disclosure.

FIG. 9 is an exploded view of an embodiment of the disclosure.

### DETAILED DESCRIPTION OF THE INVENTION

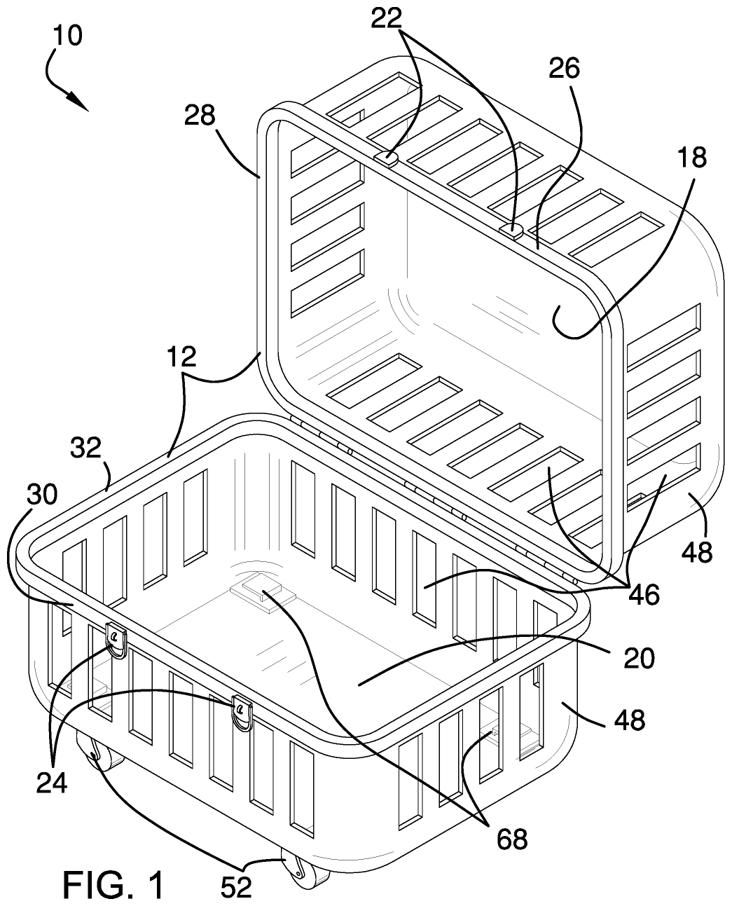

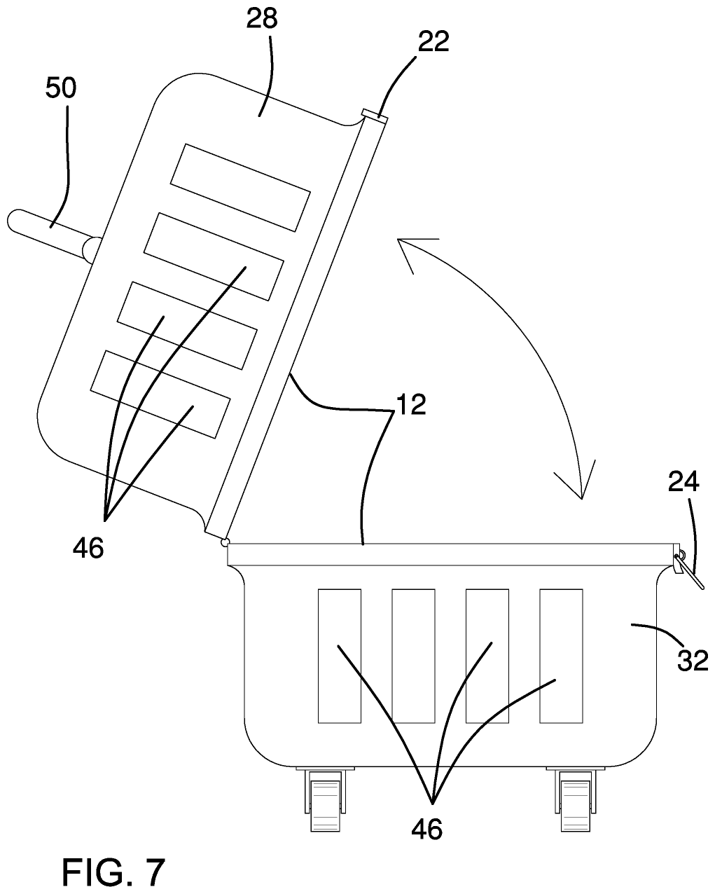

With reference now to the drawings, and in particular to FIGS. 1 through 9 thereof, a new carrying assembly embodying the principles and concepts of an embodiment of the disclosure and generally designated by the reference numeral 10 will be described.

As best illustrated in FIGS. 1 through 9, the pet carrying assembly 10 generally comprises a case 12 that defines an interior space 14. The case 12 is clam-shell type and is configured to allow a user to position a pet in the interior space 14. Prior art devices for carrying pets require the user to insert the pet into the device through a door that is positioned in an end of the device, which can be problematic, especially with feline pets. The present invention allows the pet to be lowered into the interior space 14.

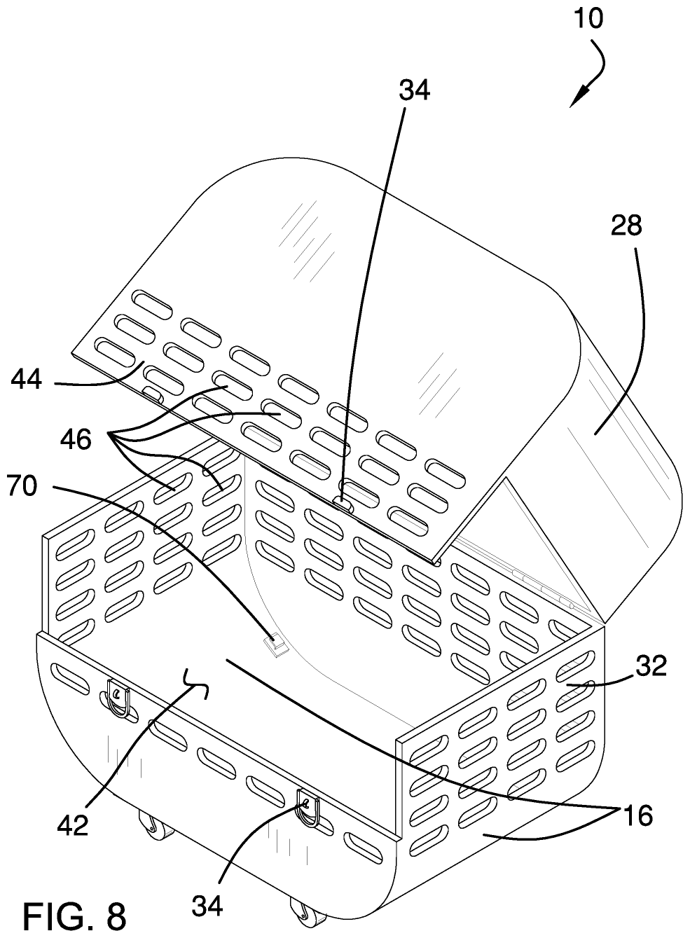

The case 12 is substantially rectangularly box shaped. The case 12 has opposing ends 16, which may be arcuate proximate to a top 18 and a bottom 20 of the case 12, as shown in FIG. 8.

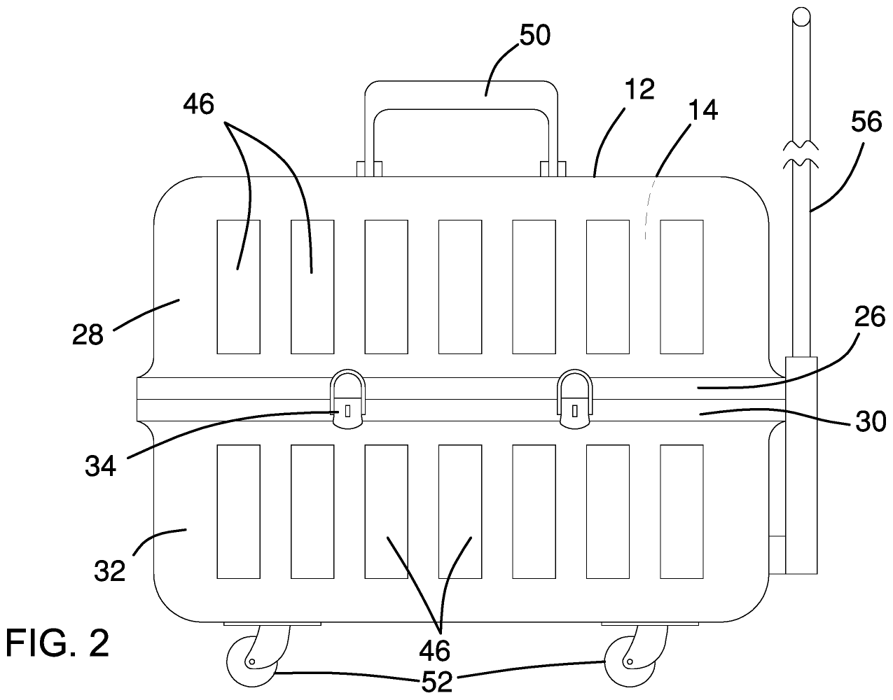

A set of first couplers 22 and a set of second couplers 24 are coupled to a forward edge 26 of an upper section 28 and a front edge 30 of a lower section 32 of the case 12, respectively, as shown in FIG. 2. The second couplers 24 are complementary to the first couplers 22 so that each second coupler 24 is positioned to be selectively coupled to an associated first coupler 22 to couple the upper section 28 to the lower section 32.

The second coupler 24 and the associated first coupler 22 may comprise a latch coupler 34, or other fastening means, such as, but not limited to, snaps, cam closures, hook and loop fasteners, and the like. The latch coupler 34 is locking type so that the latch coupler 34 is configured to deter unauthorized access to the interior space 14. The set of second couplers 24 may comprise two second couplers 24, or other number of second couplers 24, such as one, three, and four second couplers 24.

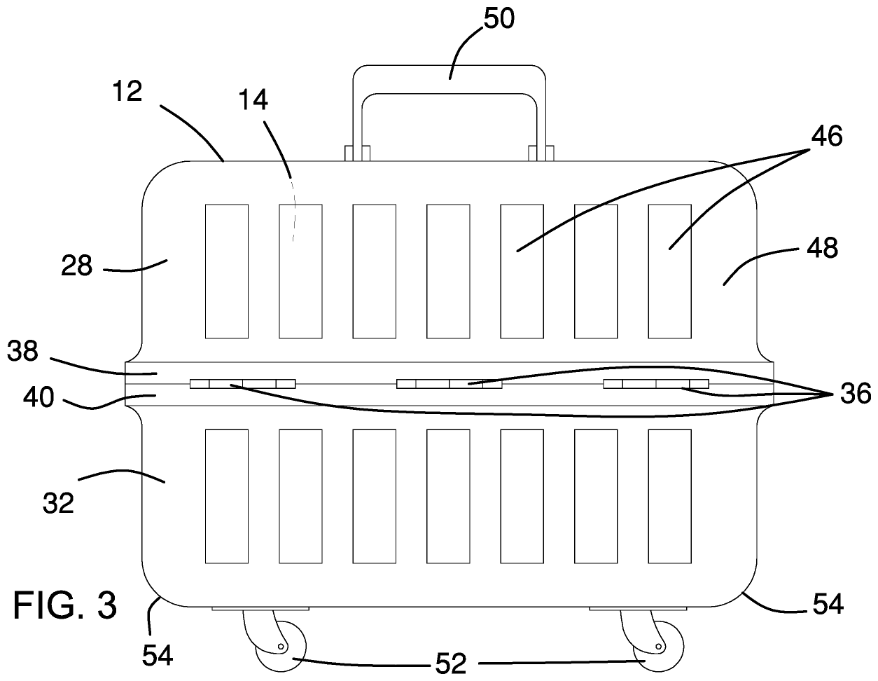

Each of a set of hinges 36 is coupled to and extends between a rear edge 38 of the upper section 28 and a back edge 40 of the lower section 32 so that the upper section 28 is hingedly coupled to the lower section 32, as shown in FIG. 3. The set of hinges 36 may comprise three hinges 36, or other number of hinges 36, such as one, two, and four hinges 36.

In another embodiment, as shown in FIG. 8, a cutout 42 extends into the lower section 32 from the front edge 30. The cutout 42 is configured to facilitate the positioning of the pet into the interior space 14. A panel 44 is coupled to and extends from the forward edge 26 of the upper section 28. The panel 44 is complementary to the cutout 42 so that the panel 44 is positioned to close the cutout 42 as the upper section 28 closes the lower section 32.

A plurality of slots 46 that is positioned in a sidewall 48 of the case 12 is configured to vent the interior space 14. The plurality of slots 46 may be positioned in the upper section 28 or both the upper section 28 and the lower section 32, as shown in FIG. 1. As shown in FIG. 8, the plurality of slots 46 may be positioned in the panel 44 and the lower section 32.

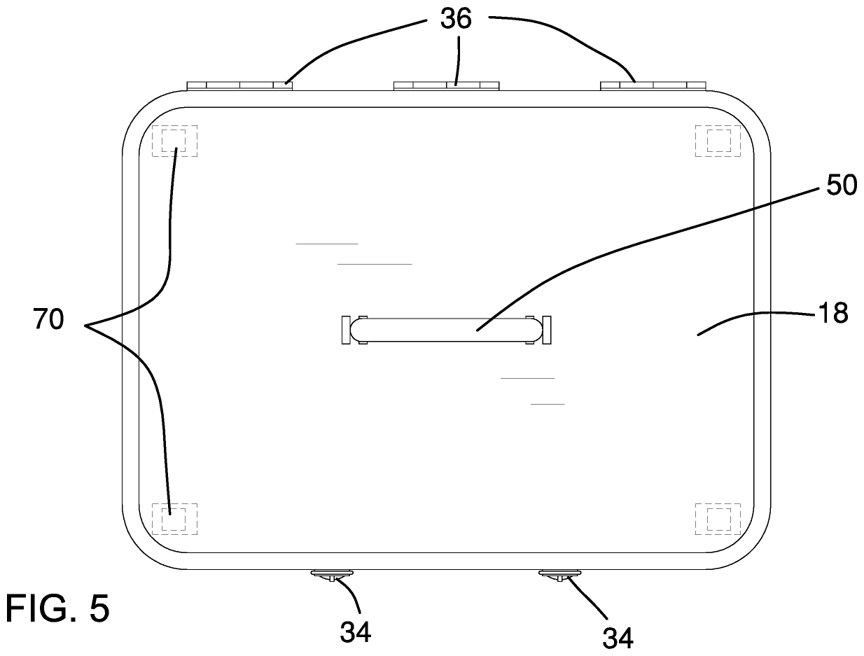

A handgrip 50 that is coupled to the top 18 of the case 12, as shown in FIG. 5, is configured to be grasped in a hand of the user to lift the case 12. The handgrip 50 is centrally positioned on and is hingedly coupled to the top 18.

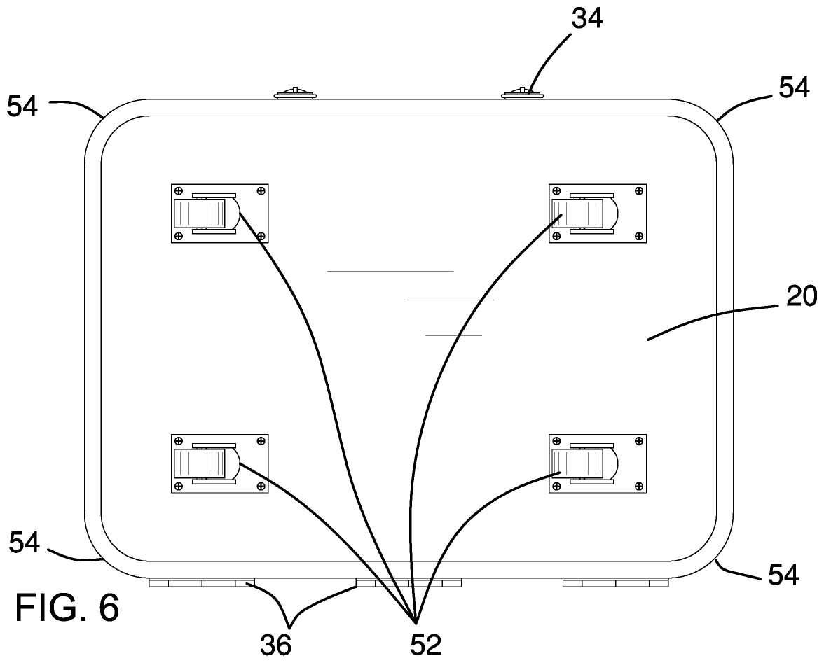

A set of rollers 52 that is coupled to a bottom 20 of the case 12, as shown in FIG. 6, is configured to locomote the case 12 across a substantially horizontal surface. The set of rollers 52 comprises four rollers 52 that are positioned singly proximate to each lower corner 54 of the case 12. The rollers 52 are castor type.

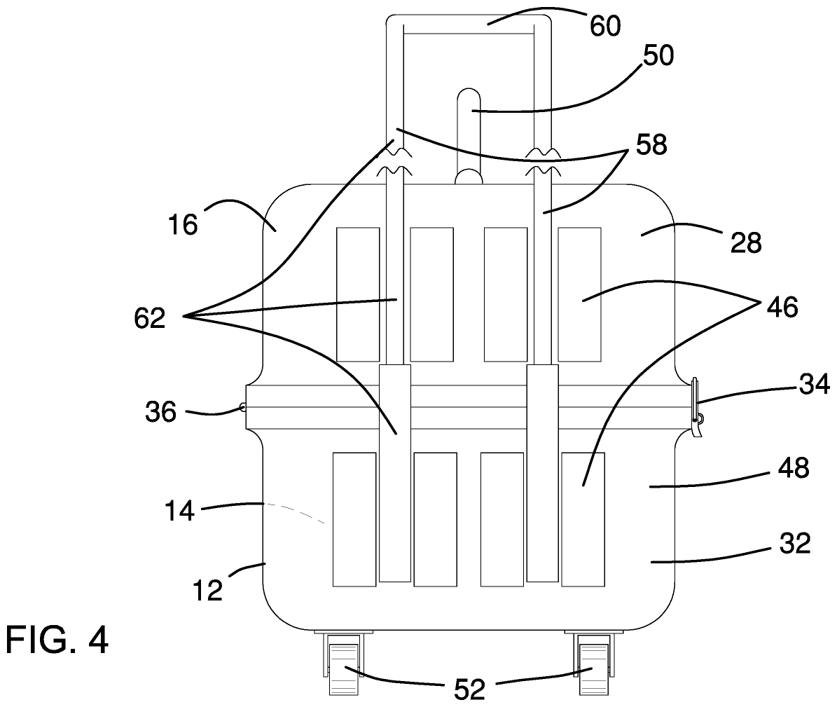

In yet another embodiment, as shown in FIGS. 2 and 4, a handle 56 is coupled to and selectively extensible from the sidewall 48 so that the handle 56 is substantially parallel to the sidewall 48 and extends above the top 18 of the case 12. The handle 56 is configured to be grasped in the hand of the user, positioning the user to locomote the case 12 upon the rollers 52 across the substantially horizontal surface. The handle 56 comprises a pair of first rods 58 and a second rod 60. Each first rod 58 comprises a plurality of nested sections 62 so that the first rod 58 is selectively extensible. The second rod 60 is coupled to and extends between the first rods 58 distal from the case 12.

A pad 64 that is selectively positionable on the bottom 20 of the case 12 within the interior space 14 is configured to cushion the case 12 and to absorb liquid, for example spilled water or urine from the pet. A set of first fasteners 66 and a set of second fasteners 68 are coupled to the pad 64 and to the bottom 20 of the case 12, respectively. The second fasteners 68 are complementary to the first fasteners 66 so that each second fastener 68 is positioned to be selectively coupled to a respective first fastener 66 to removably couple the pad 64 to the case 12.

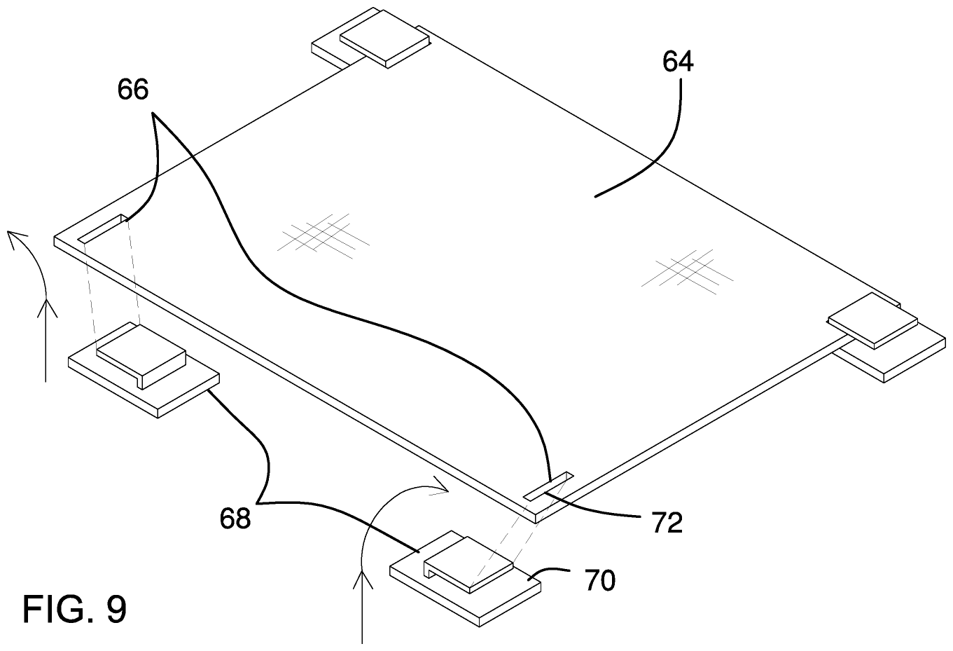

As shown in FIG. 9, the second fastener 68 may comprise a clip 70 and the respective first fastener 66 may comprise a slit 72 that is positioned in the pad 64, or other fastening means, such as, but not limited to, buttons, snaps, pressure sensitive adhesives, hook and loop fasteners, magnets, and the like. The slit 72 is positioned to insert the clip 70 to removably couple the pad 64 to the case 12. The set of second fasteners 68 comprises four second fasteners 68 that are positioned singly proximate to each lower corner 54 of the case 12.

In use, the upper section 28 is hinged relative to the lower section 32 to position the case 12 in an open configuration, allowing the user to position the pet within the interior space 14. The upper section 28 then is hinged relative to the lower section 32 to close the case 12. The latch couplers 34 are used to secure the case 12 in a closed configuration and are configured to deter unauthorized access to the interior space 14. The handgrip 50 is available to the user to lift the case 12, as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A pet carrying assembly comprising:
a case defining an interior space, the case being clam-shell type wherein the case is configured for positioning a pet in the interior space;
a set of first couplers coupled to a forward edge of an upper section of the case;
a set of second couplers coupled to a front edge of a lower section of the case, the second couplers being complementary to the first couplers such that each second coupler is positioned for selectively coupling to an associated first coupler for coupling the upper section to the lower section;
a handgrip coupled to a top of the case wherein the handgrip is configured for grasping in a hand of a user for lifting the case; and
a set of rollers coupled to a bottom of the case wherein the rollers are configured for locomoting of the case across a substantially horizontal surface.

2. The assembly of claim 1, further comprising:
the case being substantially rectangularly box shaped; and
a plurality of slots positioned in a sidewall of the case wherein the plurality of slots is configured for venting the interior space.

3. The assembly of claim 1, further including the second coupler and the associated first coupler comprising a latch coupler.

4. The assembly of claim 3, further including the latch coupler being locking type wherein the latch coupler is configured for deterring unauthorized access to the interior space.

5. The assembly of claim 1, further including the set of second couplers comprising two second couplers.

6. The assembly of claim 2, further including a set of hinges, each hinge being coupled to and extending between a rear edge of the upper section and a back edge of the lower section such that the upper section is hingedly coupled to the lower section.

7. The assembly of claim 6, further including the set of hinges comprising three hinges.

8. The assembly of claim 1, further including the plurality of slots being positioned in the upper section.

9. The assembly of claim 8, further including the plurality of slots being positioned in the upper section and the lower section.

10. The assembly of claim 2, further comprising:
a cutout extending into the lower section from the front edge wherein the cutout is configured for facilitating the positioning of the pet into the interior space; and
a panel coupled to and extending from the forward edge of the upper section, the panel being complementary to the cutout such that the panel is positioned for closing the cutout as the upper section closes the lower section.

11. The assembly of claim 10, further including the case having opposing ends, the opposing ends being arcuate proximate to the top and the bottom of the case.

12. The assembly of claim 10, further including the plurality of slots being positioned in the panel and the lower section.

13. The assembly of claim 1, further including the handgrip being centrally positioned on the top, the handgrip being hingedly coupled to the top.

14. The assembly of claim 2, further including the set of rollers comprising four rollers positioned singly proximate to each lower corner of the case, the rollers being castor type.

15. The assembly of claim 2, further including a handle coupled to and selectively extensible from the sidewall such that the handle is substantially parallel to the sidewall and extends above the top of the case wherein the handle is configured for grasping in the hand of the user positioning the user for locomoting the case upon the rollers across the substantially horizontal surface, the handle comprising a pair of first rods and a second rod, each first rod comprising a plurality of nested sections such that the first rod is selectively extensible, the second rod being coupled to and extending between the first rods distal from the case.

16. The assembly of claim 2, further including a pad selectively positionable on the bottom of the case within the interior space wherein the pad is configured for cushioning the case and for absorbing liquid.

17. The assembly of claim 16, further comprising:
a set of first fasteners coupled to the pad; and
a set of second fasteners coupled to the bottom of the case, the second fasteners being complementary to the first fasteners such that each second fastener is positioned for selectively coupling to a respective first fastener for removably coupling the pad to the case.

18. The assembly of claim 17, further including the second fastener comprising a clip, the respective first fastener comprising a slit positioned in the pad such that the slit is positioned for inserting the clip for removably coupling the pad to the case, the set of second fasteners comprising four second fasteners positioned singly proximate to each lower corner of the case.

19. A pet carrying assembly comprising:
a case defining an interior space, the case being clam-shell type wherein the case is configured for positioning a pet in the interior space, the case being substantially rectangularly box shaped, the case having opposing ends, the opposing ends being arcuate proximate to a top and a bottom of the case;
a set of first couplers coupled to a forward edge of an upper section of the case;
a set of second couplers coupled to a front edge of a lower section of the case, the second couplers being complementary to the first couplers such that each second coupler is positioned for selectively coupling to an associated first coupler for coupling the upper section to the lower section, the second coupler and the associated first coupler comprising a latch coupler, the latch coupler being locking type wherein the latch coupler is configured for deterring unauthorized access to the interior space, the set of second couplers comprising two second couplers;
a set of hinges, each hinge being coupled to and extending between a rear edge of the upper section and a back edge of the lower section such that the upper section is hingedly coupled to the lower section, the set of hinges comprising three hinges;
a cutout extending into the lower section from the front edge wherein the cutout is configured for facilitating the positioning of the pet into the interior space;
a panel coupled to and extending from the forward edge of the upper section, the panel being complementary to the cutout such that the panel is positioned for closing the cutout as the upper section closes the lower section;
a plurality of slots positioned in a sidewall of the case wherein the plurality of slots is configured for venting the interior space, the plurality of slots being positioned in the upper section, the plurality of slots being positioned in the upper section and the lower section, the plurality of slots being positioned in the panel and the lower section;
a handgrip coupled to the top of the case wherein the handgrip is configured for grasping in a hand of a user for lifting the case, the handgrip being centrally positioned on the top, the handgrip being hingedly coupled to the top;
a set of rollers coupled to the bottom of the case wherein the rollers are configured for locomoting of the case across a substantially horizontal surface, the set of rollers comprising four rollers positioned singly proximate to each lower corner of the case, the rollers being castor type;
a handle coupled to and selectively extensible from the sidewall such that the handle is substantially parallel to the sidewall and extends above the top of the case wherein the handle is configured for grasping in the hand of the user positioning the user for locomoting the case upon the rollers across the substantially horizontal surface, the handle comprising a pair of first rods and a second rod, each first rod comprising a plurality of nested sections such that the first rod is selectively extensible, the second rod being coupled to and extending between the first rods distal from the case;
a pad selectively positionable on the bottom of the case within the interior space wherein the pad is configured for cushioning the case and for absorbing liquid;
a set of first fasteners coupled to the pad; and
a set of second fasteners coupled to the bottom of the case, the second fasteners being complementary to the first fasteners such that each second fastener is positioned for selectively coupling to a respective first fastener for removably coupling the pad to the case, the second fastener comprising a clip, the respective first fastener comprising a slit positioned in the pad such that the slit is positioned for inserting the clip for removably coupling the pad to the case, the set of second fasteners comprising four second fasteners positioned singly proximate to each lower corner of the case.
